(19) United States
(12) Patent Application Publication
(10) Pub. No.: US 2020/0125966 A1
(43) Pub. Date: Apr. 23, 2020

(54) METHOD FOR DISCOVERING KNOWLEDGE AND ACTIONABLE INTELLIGENCE

(71) Applicant: MentalNotes LLC, Dallas, TX (US)

(72) Inventors: Scott Dow, Dallas, TX (US); Michael Klein, Dallas, TX (US)

(21) Appl. No.: 16/622,174

(22) PCT Filed: Jun. 15, 2018
(86) PCT No.: PCT/US18/37864

§ 371 Date: Dec. 12, 2019

Related U.S. Application Data
(60) Provisional application No. 62/521,016, filed on Jun. 16, 2017.

(51) Int. Cl. G06N 5/02; G06F 16/906

(52) U.S. Cl. CPC G06N 5/022; G06F 16/906; G06N 5/025

(57) ABSTRACT

Method to capture “knowledge” or “actionable intelligence” from structured or unstructured data sources.

### CROSS-REFERENCES TO RELATED APPLICATIONS

This application claims priority to PCT Application No. PCT/US18/37864, filed on Jun. 15, 2018 and U.S. Provisional Application No. 62/521,016, filed on Jun. 16, 2017, and incorporated, in its entirety, herein by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

Systems and methods that acquire information from structured and unstructured data sets are known in the art. Much of the prior art is focused on using natural language processing techniques to gather sentiment, emotion, and topic analysis. Referring to the figure below, prior art includes social listening platforms that use natural language processing (“NLP”) to turn “signals” into “data”, generally, by using linguistic and word count dictionaries to classify words (signals) as sentiment and emotion (data).

NLP is heavily reliant on Linguistic Inquiry and Word Count (“LIWC”) dictionaries and other similar open source dictionaries, software and resources as a means of determining sentiment and emotion found in structured and unstructured data. Part-of-speech (“POS”) tagging software has been a common tool used in NLP to aide in topic analysis.

Machine learning algorithms are limited by the amount and the type of the data collected. NLP can convert structured or unstructured data into “information” (defined as “facts provided or learned about something or someone”) but that progress stalls before it rises and meets the standard of “knowledge” (defined as “facts, information, and skills acquired by a person through experience or education”) or “actionable intelligence” (defined as “the ability to acquire and apply knowledge and skills”) because the context, concepts and definitions associated with “knowledge” or “actionable intelligence” are mostly undefined or ill-defined. Consequently, no tangible “knowledge” or “actionable intelligence” is acquired when listening to unstructured or structure social media,

For example, an organization may be able to capture data from unstructured or structured data sources such as Twitter®, Slack® or SalesForce®. The data may include information that the sales group is feeling negative (sentiment) about a new product release (topic) and worried (emotion) about pricing objections (topic). Although the organization may have a large amount of data about sentiment, topic, and emotion, the organization does not have” actionable intelligence” or “knowledge” on how to handle or manage sentiment, topic, or emotion. For the example above, actionable intelligence and/or knowledge may include data on how to increase confidence in a product release.

### BRIEF DESCRIPTION OF INVENTION

The invention described herein include system and methods to capture “knowledge” or “actionable intelligence” from structured or unstructured data sources.

### DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a flow chart showing an embodiment of the invention;

FIG. 2 is a flow chart showing an embodiment of the invention;

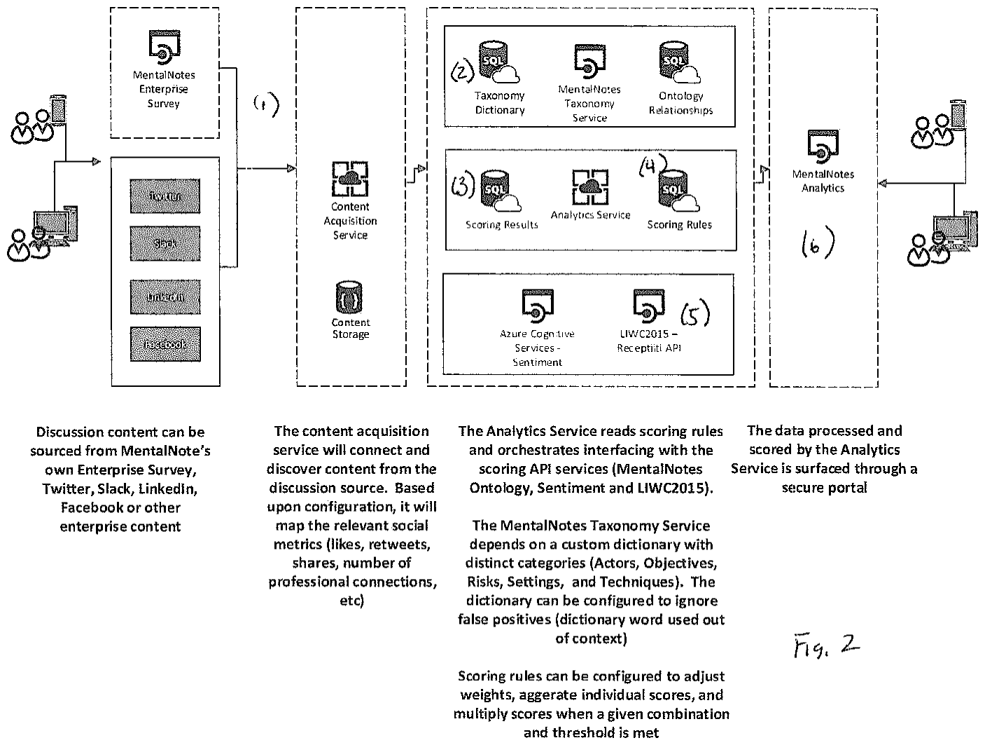

FIG. 3 is a flow chart showing an embodiment of the invention.

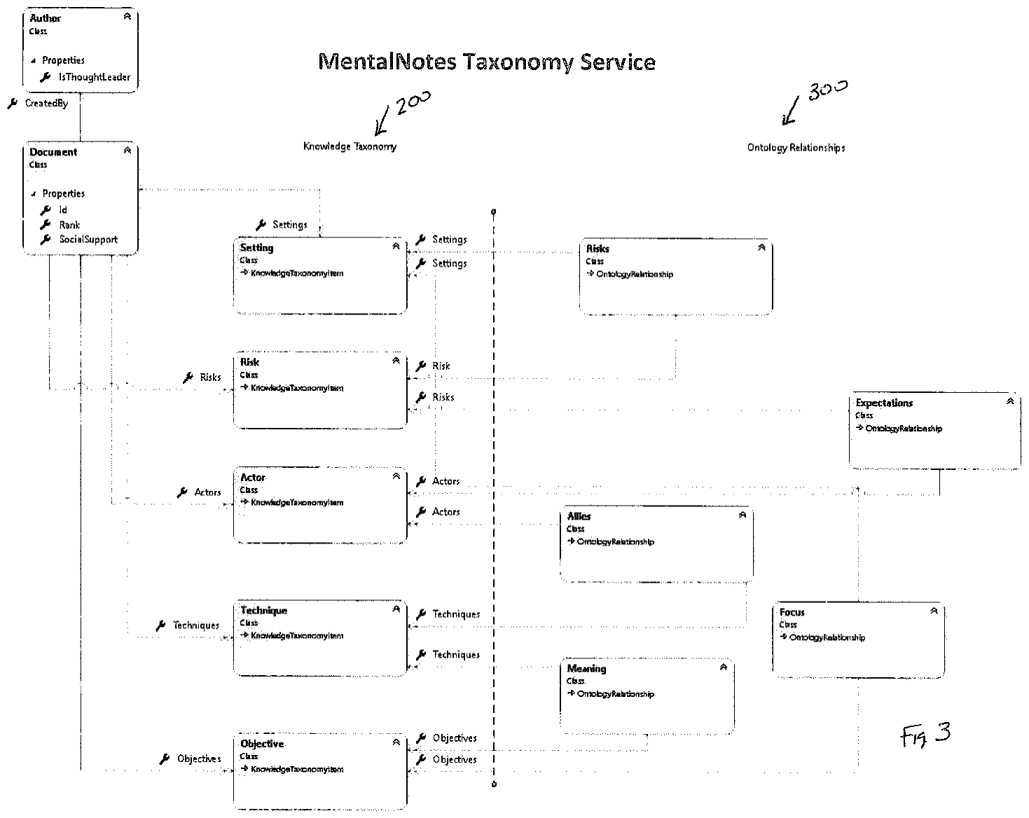

### DETAILED DESCRIPTION OF THE INVENTION

In the following detailed description, reference is made to the accompanying drawings, which form a part hereof. In the drawings, the use of similar or the same symbols in different drawings typically indicates similar or identical items, unless context dictates otherwise.

The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting. Given by way of overview, illustrative embodiments of systems and methods for gathering and analyzing knowledge or actionable intelligence from structured and unstructured data sources are provided.

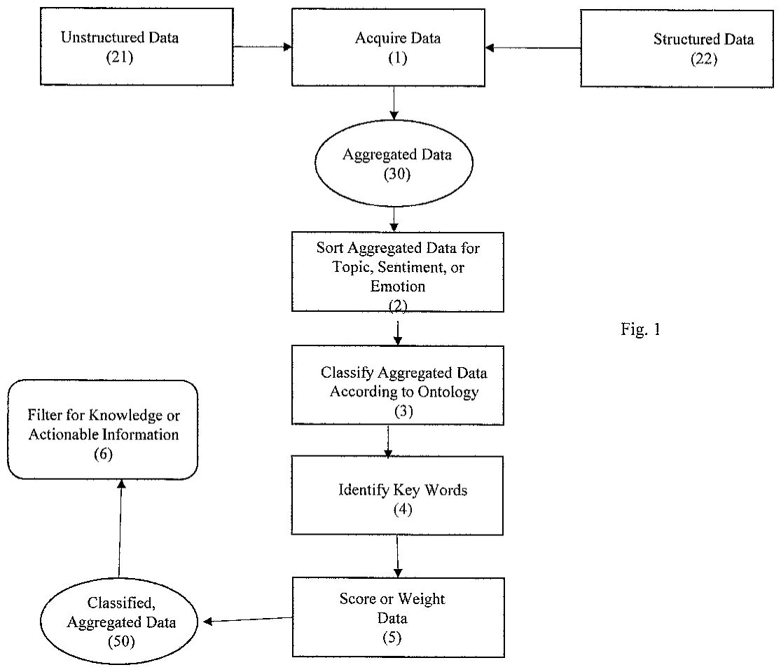

According to an embodiment, referring to FIGS. 1,2 3, a method for gathering and analyzing knowledge or actionable intelligence (100) includes aggregating data (30) from structured (22) and unstructured (21) data sources. (1) A structure data source (22) may include internal surveys; unstructured data sources (21) that may include internal sources such as blogs, email, knowledge management systems and collaboration sites, and external social media sources such as LinkedIn@ or Facebook®.

According to an embodiment, the method (100) further includes sorting aggregated data (30) for at least one topic, sentiment, or emotion. (2) According to an embodiment, the method (100) further includes classifying the aggregated data (30) into an ontology (200) that includes at least the following classifications: “actors”, “settings”. “goals/objectives”, “challenges”, and “techniques”. (3) According to an embodiment, the ontology provides context and domain specific definitions for words and phrases appearing in the aggregated data (30). For example, “patient” is an actor in healthcare while “be patient” is a technique for kindergarten teachers.

According to an embodiment, the method (100) further includes identifying parts of speech, key words and polarity using at least one LIWC dictionary. (4) According to an embodiment, the method (100) further includes scoring or weighting aggregated data (30). (5) According to an embodiment, the classified, aggregated data (30) may be weighted according to at least one topic word within at least one knowledge taxonomy; where topic word rank is calculated by combining the frequency of a topic word with its relevance in the knowledge taxonomy. According to an embodiment, the following ranking formula is used:

Rank=SUM(([@[Taxonomy Weighted]]*0.5)+([@Overall]*0.1)+([@Motivation]+[@sentiment])*0.3)+(([@[Vouch_Rank]]+[@[Impression_Rank]]+[@[Reminder_Rank]])*0.1)))

Where:
Taxonomy Weighted=(Taxonomy word count+50% bonus for risk and technique relationship)
Overall (% of all taxonomy character count)
Motivation (aggregate of off the shelf)+Sentiment (off the shelf)
Social Metrics (e.g. retweets, shares, number of professional contacts), Views, Reminder (social action).

According to an embodiment, classified, aggregated data (50) may be filtered or analyzed for knowledge or actionable intelligence. (6) According to an embodiment, the classified, aggregated data (50) may be filtered according to knowledge taxonomy (300) that includes at least the following: risks (e.g. where are the danger zones?), allies (e.g. who can help me?), focus (e.g. what should I pay attention to?), expectations (e.g. what should I prepare for?), meaning (e.g. what does “x” tell me?), and fixes (e.g. what are the solutions?). According to an embodiment, the classified, aggregated data (50) may be filtered by the relevance of a topic word within at least one knowledge taxonomy.

It will be understood by a person having ordinary skill in the art that the filtering mechanisms described above are meant for exemplary purposes; that other filtering mechanism may be used depending on the ontology and/or taxonomy. Further, a person having ordinary skill in the art will understand that each of the filtering mechanisms described above can be used alone or in combination with at least one other filtering mechanism.

For exemplary purposes, the following scenario is provided:

Corporation A ‘listens” to sales representatives “chatter” through its SalesForce® channel. Corporations A receives data indicating negative sentiment regarding a new product release and data indicating that sales representatives are worried about competitive infiltration. In the prior art, a LIWC dictionary would be used to gather information on sentiment (e.g. negative), topic (e.g. new product), and emotion (e.g. worried). Here, Corporation A may learn that 63% of its sales representatives are worried about product launch. However, there is no actionable intelligence available to Corporation A; for example, how might Corporation A increase confidence in product launch.

In accordance to the method described above, the data obtain from SalesForce® would be aggregated and classified in accordance to an ontology that includes at least the following classifications: “actors”, “settings”. “goals/objectives”, “challenges”, and “techniques. Under this ontology, a “customer” may be an “actor”. “Account review” may be a “setting”, “upgrade” may be the “goal”, “bad press” may be a “challenge”, and “free trial offering” may be a “technique”. The classified, aggregated data may be sorted with various filters including a filter that has a defined taxonomy, to find knowledge. According to an embodiment, the taxonomy is comprised of at least: “risks”, “allies”, “expectations”, “meaning”, “fixes”.

Referring to FIGS. 1,2, and 3 in embodiments, the present invention may provide for a computer program product embodied in a computer readable medium that, when executing on one or more computers, provides system and method gathering and analyzing knowledge or actionable intelligence from structured and unstructured data sources According to an embodiment, referring to FIGS. 1,2 3, a method for gathering and analyzing knowledge or actionable intelligence (100) includes aggregating data (30) from structured (22) and unstructured (21) data sources. (1) According to an embodiment, the method (100) further includes sorting aggregated data (30) for at least one topic, sentiment, or emotion. (2) According to an embodiment, the method (100) further includes classifying the aggregated data (30) into an ontology (200) that includes at least the following classifications: “actors”, “settings”. “goals/objectives”, “challenges”, and “techniques”. (3) According to an embodiment, the method (100) further includes identifying parts of speech, key words and polarity using at least one LIWC dictionary. (4) According to an embodiment, the method (100) further includes scoring or weighting aggregated data (30). (5) According to an embodiment, the classified, aggregated data (30) may be weighted according to at least one topic word within at least one knowledge taxonomy; where topic word rank is calculated by combining the frequency of a topic word with its relevance in the knowledge taxonomy. According to an embodiment, the following ranking formula is used:

Rank=SUM (([@[Taxonomy Weighted]]*0.5)+([@Overall]*0.1)+([@Motivation]+[@sentiment])*0.3)+(([@[Vouch_Rank]]+[@[Impression_Rank]]+[@[Reminder_Rank]])*0.1)))

Where:
Taxonomy Weighted=(Taxonomy word count +50% bonus for risk and technique relationship)
Overall (% of all taxonomy character count)
Motivation (aggregate of off the shelf)+Sentiment (off the shelf)
Social Metrics (e.g. retweets, shares, number of professional contacts), Views, Reminder (social action).

According to an embodiment, classified, aggregated data (50) may be filtered or analyzed for knowledge or actionable intelligence. (6) According to an embodiment, the classified, aggregated data (50) may be filtered according to knowledge taxonomy (300) that includes at least the following: risks (e.g. where are the danger zones?), allies (e.g. who can help me?), focus (e.g. what should I pay attention to?), expectations (e.g. what should I prepare for?), meaning (e.g. what does “x” tell me?), and fixes (e.g. what are the solutions?). According to an embodiment, the classified, aggregated data (50) may be filtered by the relevance of a topic word within at least one knowledge taxonomy.

It will be understood by a person having ordinary skill in the art that the filtering mechanisms described above are meant for exemplary purposes; that other filtering mechanism may be used depending on the ontology and/or taxonomy. Further, a person having ordinary skill in the art will understand that each of the filtering mechanisms described above can be used alone or in combination with at least one other filtering mechanism. It will be understood by a person having ordinary skill in the art that the filtering mechanisms described above are meant for exemplary purposes; that other filtering mechanism may be used depending on the ontology and/or taxonomy. Further, a person having ordinary skill in the art will understand that each of the filtering mechanisms described above can be used alone or in combination with at least one other filtering mechanism.

The methods and systems described herein may be deployed in part or in whole through a machine that executes computer software, program codes, and/or instructions on a processor. The present invention may be implemented as a method on a machine, as a system or apparatus as of or in relation to the machine, or as a computer program product embodied in computer readable medium executing on one or more of the machines. The processor may be part of a servicer, client, network infrastructure, mobile computing platform, stationary computing platform, or other computing platform. A processor may be any kind of computational or processing device capable of executing program instructions, codes, binary instructions and the like. The processor may be or includes a single processor, digital processor, embedded processor, microprocessor, or any variant such as a co-processor (math co-processor, graphic co-processor, communication co-processor and the like) and may directly or indirectly facilitate execution of multiple program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have been assigned priorities associated with them; the processor may execute these threads based on priority or any other order based on instructions provided in the program code. The processor may include memory that stores methods, codes, instructions and programs as described herein and elsewhere. The processor may access a storage medium associated with the processor to storing methods, programs, codes, program instructions or other types of instruction capable of being executed by the computing process device may include but may not be limited to one or more of CD-ROM, DVD, memory, hard disk, flash drive, RAM, ROM, cache, and the like.

A processor may include one or more cores that may enhance speed and performance of a multiprocessor. In embodiments, the processor may be a dual core processor, quad core processor, or other chip level multiprocessor and the like that combine two or more independent cores (called a die).

The methods and systems described herein may be deployed in part or in whole through a machine that executes computer software on a server, client, firewall, gateway, hub, router, or other such computer or networking hardware. The software program may be associated with a server that may include a file server, print server, domain server, internet server, intranet server, and other variants such as secondary server, host server, distributed server, and the like. The server may include one or more of memories, processors, computer communication devices, and interfaces capable of accessing other client servers, clients, machines, and devices through wired or wireless medium, and the like. The methods, programs or codes described herewith and elsewhere may be executed by the server. In addition, other devices required for execution of methods as described in this application as part of an infrastructure associated with the server.

The server may provide an interface to other devices including, without limitation, clients, other servers, printers, database servers, print servers, file servers, communication servers, distributed servers and the like. Additionally, this coupling and connection may facilitate remote execution of program across the network. The networking of some or all of these devices may facilitate parallel processing of a program or method at one or more locations without deviating from the scope of the invention. In addition, any of the devices attached to the server through an interface may include at least one storage medium capable of storing methods, programs, code and/or instructions to be executed on different devices. In this implementation, the remote repository may act as a storage medium for program code, instructions, and programs.

The software program may be associated with a client that may include a file client, print client, domain client, internet client, and other variants such as secondary clients, host clients, distributed clients and the like. The client may include one or more memories, processors, computer readable media, storage media, ports (physical and virtual). Communication devices, and interfaces capable of accessing other clients, servers, machines, and devices, and interfaces capable of accessing other clients, servers, machines, and devices, through a wired or wireless medium, and the like. The methods, programs or codes as described herein and elsewhere may be executed by the client. In addition, other devices required for execution of the methods as described herein this application may be considered as a part of the infrastructure associated with the client.

The client may provide an interface to other devices including without limitation, servers, other clients, printers, data-based servers, file servers, communications servers, distributed servers and the like. Additionally, coupling and/or connection may facilitate remote execution of program across the network. The networking of some or all of the devices may facilitate parallel processing of a program or method at one or more locations without deviating from the scope of this invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The method and systems described herein may be deployed in part or in whole through network infrastructures. The network infrastructure may include elements such as computing devices, servers, routers, hubs, firewalls, clients, personal computers, communication devices, routing devices, and other active and passive devices, modules and/or components known in the art. The computing and or non-computing device(s) associated with the network infrastructure may include, apart from other components, a storage medium such as flash memory, buffer, stack, RAM, ROM, and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be GSM, GPRS, #G 4G, EVDO, mesh, or other network types.

The methods, programs, codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as a flash memory, buffer, RAM, ROM, and one or more computing devices. The computing devices associated with mobile devices maybe enabled to execute program codes, methods, and instructions stored thereon. Alternatively, the mobile device maybe configured to execute instructions in collaboration with other devices. The mobile devices may communicate on a peer to peer network. The program code maybe stored on the storage medium associated with the server and executed by a computing device embedded within the server. The base station may include a computing device and a storage medium. The storage device may store program code and instructions executed by computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage such as optical discs, forms of magnetic storage, like hard disks, tapes, drums, cards, and other types; processor registers, cache memory, volatile memory, non-volatile memory, optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, network attached storage, file addressable, content addressable, network, barcodes, magnetic ink, and the like.

The methods and systems described herein may transform physical and/or intangible items from one state to another. The methods and systems or intangible items from one state to another. The methods and systems described herein may also transform data representing physical and/or intangible items from one state to another.

The elements described and depicted herein, including flow charts and block diagrams throughout the figures, imply logical boundaries between the elements. However, according to software or hardware engineering practices, the depicted elements and functions thereof may be implemented on machines through computer executable media having a processor capable of executing program instructions, as standalone software modules, or as modules that employ external routines, codes, services, and so forth, or any combination of these, and all such implementations maybe within the scope of the present disclosures.

I claim as my invention:

1. A computer-implemented method for gathering and analyzing knowledge or actionable intelligence, the method comprising:
aggregating data from structured and unstructured data sources;
processing data for topic, sentiment, emotion or a combination thereof;
processing data into an ontology;
processing aggregated data for parts of speech, key words and polarity using at least one LIWC dictionary;
scoring and weighting processed data;
curating information related to scored and weighted data;
providing to a smart device curated information.

2. The computer-implemented method of claim 1 where unstructured data sources includes blogs, emails, knowledge management systems, collaboration sites, social media sites.

3. The computer-implemented method of claim 1 where the ontology includes at least the classifications “actors”, “settings”. “goals/objectives”, “challenges”, and “techniques”.

4. The computer-implemented method of claim 3 where the ontology includes context and domain information.

5. The computer-implemented method of claim 1 where processed data is scored and weighted according to the following:
Rank=SUM(([@[Taxonomy Weighted]]*0.5)+([@Overall]*0.1)+([@Motivation]+[@ sentiment])*0.3)+(([@[Vouch_Rank]]+[@[Impression_Rank]]+[@[Reminder_Rank]])*0.1)))

6. The computer-implemented method of claim 1 where aggregated data is filtered for knowledge or actionable intelligence.

7. The computer-implemented method of claim 1 where aggregated data is filtered according to a knowledge taxonomy.

8. The computer-implemented method of claim 7 where the knowledge taxonomy includes at least: risk, allies, expectations, and fixes.

9. The computer-implemented method of claim 7 where the aggregated data is filter by relevance of topic word.
